(19) United States
(12) Patent Application Publication
(10) Pub. No.: US 2004/0050875 A1
(43) Pub. Date: Mar. 18, 2004

(54) Liquid dispenser for liquid container

(76) Inventor: Yasushi Kobayashi, Ashikaga-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/606,734

(22) Filed: Jun. 27, 2003

(30) Foreign Application Priority Data
Feb. 12, 2002 (JP) 2002-350007

(51) Int. Cl. G01F 11/06

(52) U.S. Cl. 222/333

(57) ABSTRACT

A liquid dispenser for a cap which is fitted to a mouth of a container holding a liquid therein includes a liquid-lifting device supported on an upper wall of the cap as pierced therethrough and including a helical screw and a cylindrical tube encompassing the helical screw, both having upper terminal parts thrust upward individually from the upper wall and lower terminal parts inserted into the container when the cap is fitted to the mouth of the container; and a housing adapted to accommodate therein a helical screw-driving device for rotating the helical screw in the liquid-lifting device and furnished with a delivery nozzle for allowing a liquid lifted by the liquid-lifting device to flow out of the liquid dispenser.

### BACKGROUND OF THE INVENTION

1. Field of the Invention

This invention relates to a liquid dispenser that is attached to the mouth of a container holding a viscous liquid, such as shampoo, body soap or hand soap and used for drawing a proper amount of the liquid from within the container.

2. Description of the Prior Art

Liquid dispensers of this class have been publicly known to date. Such known liquid dispensers generally have erected from the center of a cap fitted to the mouth of a container an operating mallet provided on the upper end thereof with an operating piece and are enabled by the principle of an air pump, i.e. by giving a push to the operating piece with the user's palm till the operating mallet is depressed, to induce the outflow of a liquid contained in the container through a delivery nozzle formed in the cap. Thus, the user is expected to use one of his palms for receiving the liquid emanating from the delivery nozzle and the other palm for depressing the operating mallet together with the operating piece for the purpose of drawing a proper amount of the liquid contained in the container.

Since this liquid dispenser requires use of both of the user's hands in drawing the liquid from the container, this liquid dispenser cannot be utilized when one of the user's hands is occupied in some work or other. Further, since the shampoo, body soap or hand soap that is contained in the container has high viscosity, the depression of the operating mallet of the operating piece necessitates exertion of a considerable amount of force. Children and old people cannot easily operate this liquid dispenser.

### SUMMARY OF THE INVENTION

With a view to solving the problem mentioned above, this invention provides a liquid dispenser for a cap which is fitted to a mouth of a container holding a liquid therein, which liquid dispenser comprises a liquid-lifting means supported on an upper wall of the cap as pierced therethrough and comprised of a helical screw and a cylindrical tube encompassing the helical screw, both having upper terminal parts thrust upward individually from the upper wall and lower terminal parts inserted into the container when the cap is fitted to the mouth of the container; and a housing adapted to accommodate therein a helical screw-driving means for rotating the helical screw in the liquid-lifting means and furnished with a delivery nozzle for allowing a liquid lifted by the liquid-lifting means to flow out of the liquid dispenser.

In the liquid dispenser mentioned above, the helical screw-driving means is adapted to transmit a driving force of an electrical driving source and rotate the helical screw, and the housing is provided at a proper position thereof with a switch for driving and stopping the electrical driving source.

In the second mentioned liquid dispenser, the housing is comprised of a lower case having an empty storage part for accommodating the helical screw-driving means and a top face opening, and an upper case of a shape of a cover for blocking the top face opening of the lower case; the upper case is made of a material capable of deformation under an external force and restoration to an original shape by itself from the deformation and is furnished with a thin-wall part so as to function as a switching part capable of deformation under an external force and restoration to an original shape by itself from the deformation, and the switching part is consequently adapted to turn on the electrical driving source by application of an external pressure for depressing the switching part into the housing and turn off the electrical driving source by releasing the external force applied to the switching part, thereby allowing the switching part to resume an original state.

In the first mentioned liquid dispenser, the delivery nozzle of the housing is disposed in an upward direction for enabling a liquid lifted by the liquid-lifting means to advance through an upwardly inclined path and reach an exhaust port and the delivery nozzle is provided in a lower part of the exhaust port with a liquid flow-inhibiting means for inhibiting a discharged liquid from flowing out of the exhaust port, down a lower face of an outer tube of the nozzle, toward a main body side of the housing.

In the first mentioned liquid dispenser, the liquid-lifting means is provided at a terminal part of the helical screw with first attaching-detaching means, and the liquid dispenser further comprises second liquid-lifting means comprising a second helical screw and a second cylindrical tube encompassing the second helical screw and provided at a terminal part of the second helical screw with second attaching-detaching means so that the two liquid-lifting means are rendered attachable and detachable through the first and second attaching-detaching means, whereby the liquid-lifting means is adapted for extension and has a lifting path therein rendered extendable proportionately to a depth of the container.

In any one of the third- to fifth-mentioned liquid dispensers, the switching part is provided with an auxiliary switching piece shaped to cover at least the switching part of the housing and rendered shiftable between a state incapable of acting on the switching part and a state capable of depressing the switching part, and the electrical driving source of the helical screw-driving means is switched by a shifting motion of the auxiliary switching piece.

In any one of the third- to sixth-mentioned liquid dispensers, the helical screw-driving means comprises a motor having a rotational shaft disposed in a lateral direction therein, which motor is the electrical driving source, a driving force-transmitting mechanism for transmitting rotation of the rotational shaft as the driving force for the helical screw, and a laterally disposed battery for feeding electricity to the motor to complete the housing in a thin construction.

In the first mentioned liquid dispenser, the liquid-lifting means has in an upper part thereof an air-bubble mixing part comprising a diametrically enlarged helical screw and a diametrically enlarged cylindrical tube, and the lifted liquid is foamed in the air-bubble mixing part and allowed to flow out of the liquid dispenser through the delivery nozzle.

Since the liquid dispenser of this invention for the container holding a liquid therein uses the liquid-lifting means which is comprised of the helical screw and the cylindrical tube as described above, it is enabled to draw the liquid held in the container through the delivery nozzle by rotating the helical screw through the helical screw-driving means. It is, therefore, capable of lifting not only a highly viscous liquid, such as shampoo or rinse, but also a fluid of extremely high viscosity, such as grease. Even in the case of the container of a comparatively large size that holds the liquid for delivery in a large quantity, the difficulty encountered by children and old people in manipulating the conventional air pump type liquid dispenser can be effectively prevented because the load spent in rotating the helical screw cannot increase extremely.

Further, since the helical screw-driving means is made to be driven and stopped with the switch which is disposed in the housing, the liquid dispenser is enabled to lift the liquid exclusively more easily.

The above and other objects and characteristic features of this invention will become apparent from the following detailed description based on the accompanying drawings.

### BRIEF EXPLANATION OF THE DRAWING

FIG. 1 is a longitudinally sectioned side view illustrating the first embodiment of a liquid dispenser of this invention.

FIG. 2 is a magnified diagram of the essential part of the liquid dispenser of FIG. 1.

FIG. 3 is a longitudinally sectioned front view taken through FIG. 2 along line III-III.

FIG. 4 is a plan view illustrating the liquid dispenser of FIG. 1, with the cover of a housing removed to reveal the interior to advantage.

FIG. 5 is an explanatory diagram of a battery, a motor, a switch and a contact piece in the liquid dispenser of FIG. 1.

FIG. 6 is a circuit diagram illustrating one example of the electric circuit in the liquid dispenser of FIG. 1.

FIG. 7 is a magnified longitudinally sectioned side view illustrating the essential part of the second embodiment of the liquid dispenser of this invention.

FIG. 8 is a longitudinally sectioned side view illustrating the state of elongating a liquid-lifting means in the liquid dispenser of FIG. 7.

FIG. 9 is a longitudinally sectioned side view of the third embodiment of the liquid dispenser of this invention.

FIG. 10 is a longitudinally sectioned side view of the fourth embodiment of the liquid dispenser of this invention.

FIG. 11 is a cross section taken through FIG. 10 along line XI-XI.

FIG. 12 is a longitudinally sectioned side view of the fifth embodiment of the liquid dispenser of this invention.

FIG. 13 is a perspective view of the appearance of a housing furnished with an auxiliary switching piece in the liquid dispenser of FIG. 12.

FIG. 14 is a magnified longitudinally sectioned side view of the essential part of the sixth embodiment of the liquid dispenser of this invention.

FIG. 15 is a front view of a housing in the liquid dispenser of FIG. 14.

FIG. 16 is a front view of a battery case in the liquid dispenser of FIG. 14.

FIG. 17 is a longitudinally sectioned side view of the seventh embodiment of the liquid dispenser of this invention.

### DESCRIPTION OF THE PREFERRED EMBODIMENTS

The liquid dispenser of this invention for a container holding a liquid therein will be described in detail below with reference to the accompanying drawings.

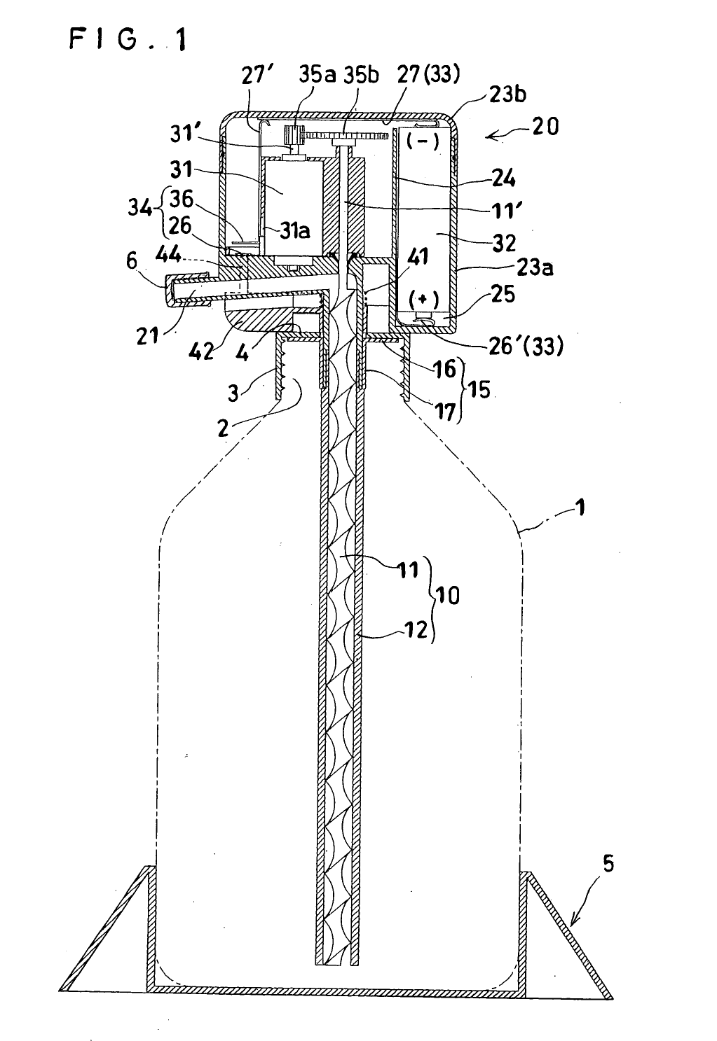

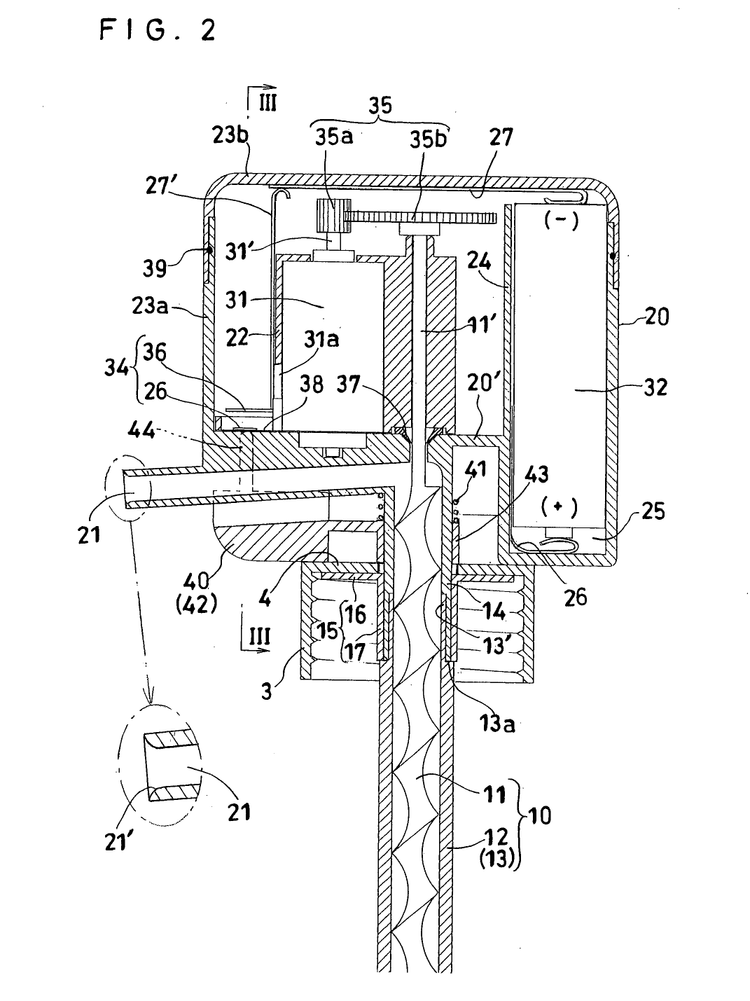

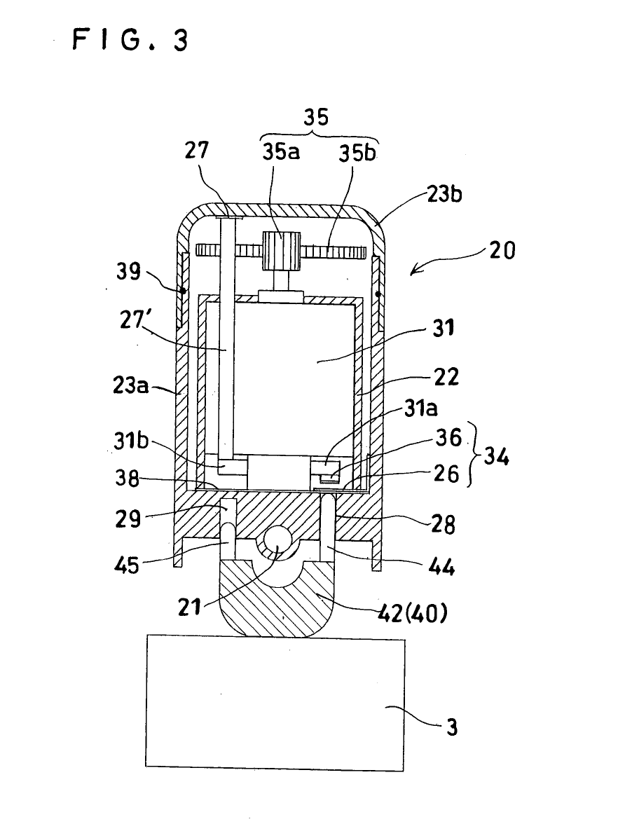

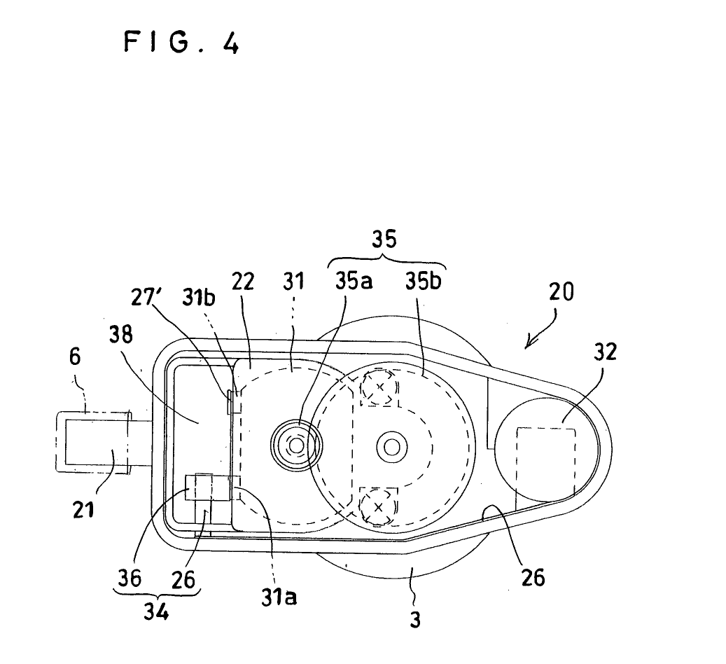

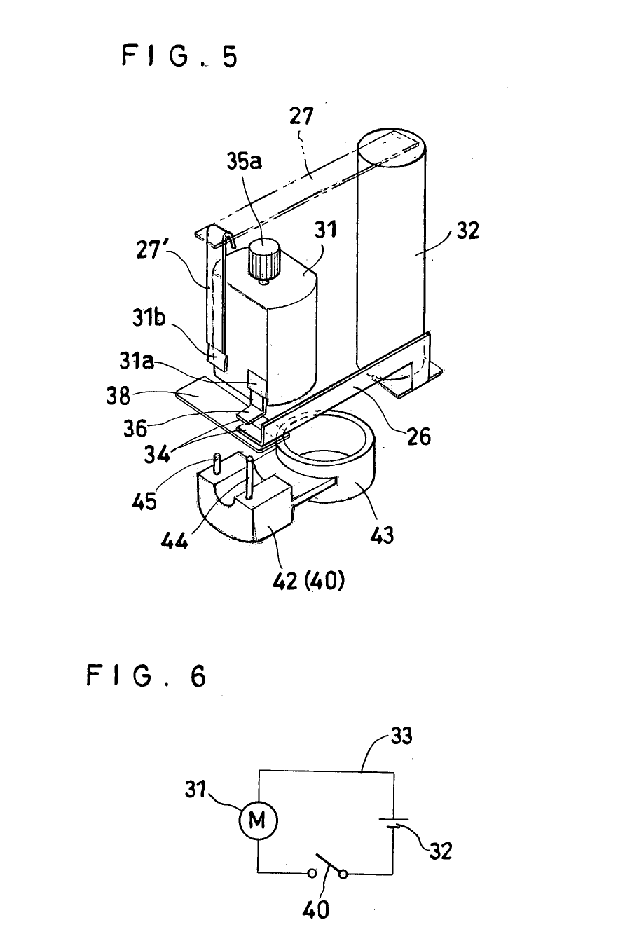

The liquid dispenser according to the first embodiment of this invention is illustrated in FIG. 1 to FIG. 6. In the diagrams, reference numeral 1 denotes a container holding therein a viscous liquid, such as shampoo, and numeral 2 denotes the mouth of the container 1 which is provided on the outer periphery thereof with an external thread and consequently enabled to have a cap 3 driven onto the mouth along an internal thread formed on the inside perimeter thereof till it is fastened thereto.

A liquid-lifting means denoted by reference numeral 10 comprises a helical screw 11 and a cylindrical tube 12 enclosing the helical screw 11, both having the upper terminal parts individually thrust upward from an upper wall 4 of the cap 3 and the lower terminal parts inserted into the container 1 when the cap 3 is mounted on the mouth 2.

A housing denoted by reference numeral 20 is separately formed of a plastic material and disposed on the upper wall 4 of the cap 3. It is adapted to accommodate therein the upper terminal parts of the helical screw 11 and cylindrical tube 12 thrust upward from the upper wall of the cap, a motor 31 which is an electrical driving source for imparting rotation to the helical screw, a battery 32 for feeding electricity to the motor, an electric circuit 33 intervening between the motor and the battery, and an electric contact 34 normally kept OFF in the circuit. It is furnished with a delivery nozzle 21 slanted downward for enabling a liquid to flow out from the upper end of the cylindrical tube 12.

The motor 31 is accommodated in the housing 20, with a shaft 31′ thereof directed upward, and a shaft 11′ of the helical screw 11 is rotatably supported in the housing 20 as thrust upward from the cylindrical tube and made to remain parallel with the shaft 31′ of the motor so as to transmit the rotation of the motor shaft with a reducing gears' transmission device 35 to the shaft 11′ of the helical screw and eventually set the helical screw 11 rotating. Thus, the housing 20 serves the purpose of accommodating therein a helical screw-driving means that comprises the motor 31, the battery 32 and the reducing gears' transmission device 35.

In the first embodiment illustrated, the cylindrical tube 12 comprises a main tube 13 converging toward the upper terminal part 13′ thereof and terminating in the upper wall 4 of the cap 3 and a junction tube 14 formed integrally with the housing 20 as directed downward, having a smaller outside diameter than the main tube 13, fitting with the outer periphery of the converging upper terminal part 13′ of the main tube 13 and penetrating the upper wall 4 of the cap, and having the upper terminal thereof communicate with the delivery nozzle 21. For the sake of preventing the liquid held in the container 1 from leaking out and flowing down the junction tube 14 penetrating the upper wall 4 of the cap, the cap is provided with an inside plug 15 which is made of synthetic resin and formed of a disk part 16 contiguous to the lower surface of the upper wall of the cap and a cylindrical part 17 fitting with the outer periphery of the junction tube 14. The lower end of the junction tube 14 mentioned above and the lower end of the cylindrical part 17 of the inside plug 15 collide as illustrated with a lower terminal step 13a of the converging upper terminal part 13′ of the main tube 13 and, consequently, the inside plug 15 fulfills the role of taking hold of the main tube 13 of the cylindrical tube and the junction tube 14 of the housing with the cylindrical part 17 and also the role of retaining the cap 3 and the housing 20 tightly.

Further in the present embodiment, the housing 20 is furnished above the delivery nozzle 21 with a flat inside bottom 20′ , and the motor 31 is accommodated on the inside bottom 20′ with the shaft 31 ′ directed upward. A motor case 22 disposed on the inside bottom 20′ covers the motor 31 from above. The shaft 11′ of the helical screw thrust upward from the inside bottom 20′ penetrates the motor case 22. Preferably, this motor case 22 is fixed on the inside bottom 20′ as with machine screws. The motor case 22 is fixed after the fashion of a cover on the motor or the shaft 11′ before gears 35a and 35b are attached to the shaft 31′ of the motor and the shaft 11′ of the helical screw. The gears 35a and 35b are thereafter fixed to the relevant shafts as meshed therewith.

Incidentally, the housing 20 in the present embodiment is formed of a top face opening lower case 23a furnished with an empty part for accommodating the helical screw-driving means and an upper case 23b of the shape of a cover serving the purpose of blocking off the top face opening of the lower case 23a. The top face opening of the lower case 23a is closed with the upper case 23b that is removable. Inside the housing, a battery chamber 25 is defined with a partition 24 and the battery chamber 25 has slender dry cells 32 accommodated vertically therein. One battery or a plurality of batteries connected in series electrically suffices to actuate the liquid dispenser. The battery or batteries are accommodated in the battery chamber 25 after the upper case 23b has been unfastened. The bottom of the battery chamber 25 occupies a lower position than the inside bottom 20′ of the housing.

The electric circuit 33 which electrically connects the electric poles at the upper and lower terminals of the battery to two terminals 31a and 31b of the motor 31 is furnished with a first contact piece 26 having one terminal part thereof contact the lower end (+pole) of the battery on the bottom of the battery chamber 25 and a second contact piece 27 disposed on the lower surface of the upper case 23b and adapted to have one terminal part thereof contact the upper end (−pole) of the battery when the upper case 23b is fixed after the fashion of a cover on the lower case 23a.

The first contact piece 26 rises inside the battery chamber along the partition 24, then bends and passes through a slit formed in the partition, and extends on the inside bottom 20′ along the motor case 22 till the leading terminal thereof reaches the underside of a contact piece 36 having the upper end thereof fixed to the (+) terminal 31a of the motor.

The other terminal part of the second contact piece 27 which is fixed to the lower surface of the upper case 23b and adapted to have one terminal part thereof contact the upper terminal (+pole) of the battery is allowed, when the upper case 23b is fixed after the fashion of a cover on the lower case 23a, to contact the upper terminal part of an auxiliary contact piece 27′ having the lower terminal thereof contact the (−) terminal 31b of the motor. This contact piece 27′ is fixed in the vertical direction to the lateral surface of the motor case. The contact pieces 26, 27, 27′ and 36 are made of leaf spring.

The contact piece 36 of the (+) terminal 31a of the motor and the leading end of the first contact piece 26 are separated to normally form the electric contact 34 of the OFF status. Therefore, when the leading end of the first contact 26 is pushed up in spite of the elasticity thereof with a switch 40 and allowed to contact the contact piece 36 of the (+) terminal 31a of the motor to turn ON the electric contact 34, the electric circuit 33 is closed and the helical screw 11 is set rotating by the motor 31.

The switch 40 is furnished with a switch button 42 which is fixed vertically movably to the underside of the housing and constantly pressed against the upper wall of the cap 3 by the use of a spring 41. The switch button 42 is extended downward from a point falling halfway along the length of the delivery nozzle 21 of the housing and is furnished in the rear terminal part thereof with a cylindrical part 43 fitting vertically movably with the outer periphery of the junction tube 14. The spring 41 is inserted in the junction tube 14, with the upper end thereof received by the delivery nozzle 21 and the lower end thereof enabled to give a downward push to the cylindrical part 43. As a result, the lower surface of the switch button 42 is pressed against the upper wall of the cap 3.

The switch button 42 is furnished at the bilateral sides of the front end thereof with a pin 44 of a large length directed upward (occasionally referred to briefly as “long pin”) and a pin 45 of a small length (occasionally referred to briefly as “short pin”). The housing is furnished at the bilateral sides of the delivery nozzle 21 with a through hole 28 allowing the long pin 44 to make a complete plunge therein from below and a blind hole 29 closed in the upper end thereof and allowing the short pin 45 to make a shallow plunge therein. The upper end of the through hole 28 occupies a position below the leading end of the first contact piece 26 which constantly forms the electric contact 34 in the OFF status. Incidentally, the front terminal part of the switch button 42 thrusts outward from the upper wall of the cap 3.

When the front terminal part of the switch button 42 is pushed up as with a finger or the edge of a vessel used for introducing a liquid into the container 1, therefore, the switch button 42 rises by overcoming the downward pressure of the spring 41 and consequently the long pin 44 rises inside the through hole 28 till the upper end thereof thrusts upward from the through hole and knocks up the leading terminal part of the first contact piece 26 in spite of the elasticity thereof and brings it into contact with the contact piece 36 of the (+) terminal 3 la of the motor. Since the motor rotates consequently and imparts a rotational motion to the helical screw 11, the viscous liquid in the container 1 rises inside the cylindrical tube 12, flows into the delivery nozzle 21 past the upper end of the cylindrical tube, and flows down into the vessel through the leading end of the delivery nozzle. This motion of the liquid continues while the switch button 42 is kept pushed up.

The short pin 45 has the upper end thereof collide against the upper end of the blind hole 29 when the switch button 42 is pushed up and thus functions as a stopper for preventing the switch button from being further pushed up forcibly.

When the upward push of the switch button is stopped, the motor and the helical screw cease their rotations because the switch button is returned by the spring force to the lowermost position at which it collides against the upper wall of the cap and the leading terminal part of the first contact piece 26 separates downward from the contact piece 36. At this time, the empty space intervening between the lower end of the cylindrical tube 12 and the leading end of the delivery nozzle 21 is filled with the viscous liquid. When the inside perimeter of the leading terminal part of the delivery nozzle is diverged in the direction of the leading end thereof with an arcuate taper to give rise to an enlarged part 21′ with a view to preventing the viscous liquid from drooping down past the leading end of the delivery nozzle 21, the liquid can be prevented from drooping down unexpectedly because the liquid held in the enlarged part 21′ flows down by following the trailing end of the flow till the liquid ceases to exist in the enlarged part 21′ when the motor and the helical screw cease their rotations and the viscous liquid ceases its emanation.

The hole formed in the inside bottom 20′ of the housing and intended to be penetrated by the shaft 11′ of the helical screw may be fitted with annular packing 37 for the sake of preventing the viscous liquid from flowing down the shaft 11′ and eventually leaking out onto the inside bottom 20′ . It is also permissible to have plate-like packing 38 spread in the neighborhood of the inside bottom 20′ in which the upper end of the through hole 28 opens with a view to preventing the viscous liquid from establishing a short circuit between the leading terminal part of the first contact piece 26 and the (+) terminal 31a of the motor.

The lower terminal part of the container 1 may be inserted in the inside perimeter of a pedestal 5 for the purpose of allowing the container bottom to stand steadily.

The leading end of the delivery nozzle 21 may be kept stoppered with a plug 6 while the delivery nozzle 21 is not in use lest the liquid held in the bottom 1 should dry, succumb to degeneration due to exposure to the ambient air, or leak out of the container while the container is being conveyed.

The electric circuit 33 to be used in the first embodiment described above is constructed as illustrated in FIG. 6.

It is also permissible to have annular packing 39 attached to the outer periphery of the upper part of the lower case 23b that is to be covered with the upper case 23b so that the packing 39 may protect the interior of the housing against immersion of water when the lid is set in place.

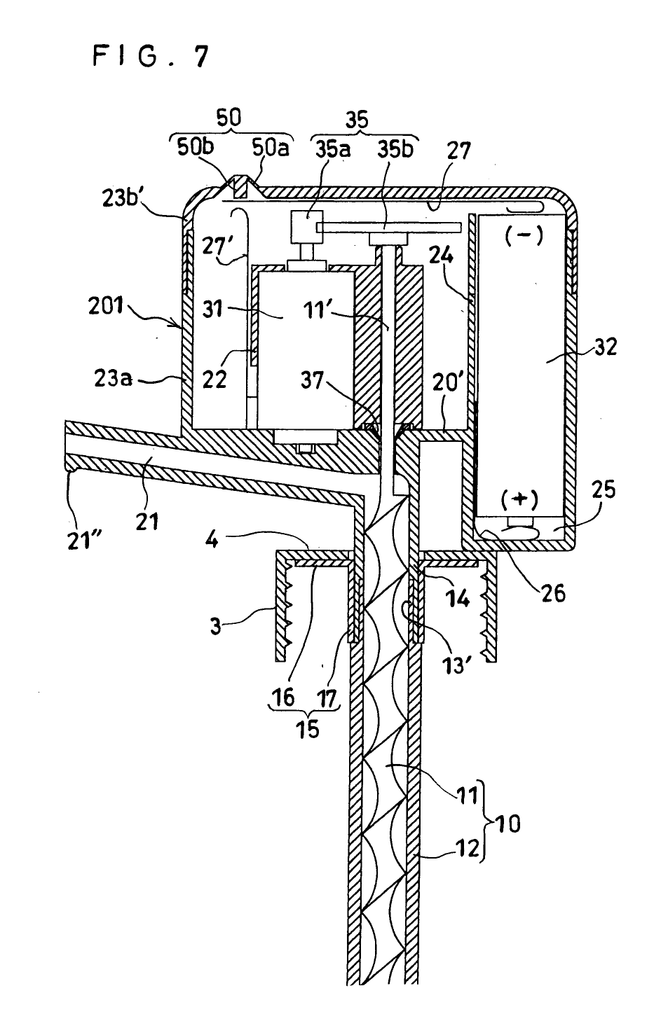

In the first embodiment described above, the delivery nozzle 21 has been described as being disposed in a downward direction. The disposition of the delivery nozzle 21 does not need to be particularly limited to this direction. The switch for the delivery of the liquid does not need to be provided exclusively in the lower part of the housing. Now, the liquid dispenser according to the second embodiment of this invention will be described in detail below with reference to FIG. 7. In this diagram, like functions found in the preceding diagrams illustrating the first embodiment will be denoted by like reference numerals. They will be omitted from the following description.

In the liquid dispenser illustrated in the second embodiment, a housing 201 is formed of the lower case 23a and the upper case 23b′ and the delivery nozzle 21 projected from the lower part of the housing 201 is disposed in an upward direction so that the liquid conveyed by a liquid-conveying means may reach the exhaust port via a path inclined upward, and the exhaust port is provided in the lower part thereof (the region in which the part of the discharge liquid which has failed to fall down completely and has flowed along the edge part of the exhaust port is collected) with a salient part 21″ as a means for preventing the liquid from flowing down. By thus providing this salient part 21″, it is made possible to prevent the discharge liquid from flowing out of the exhaust port down to the main body side of the housing via the lower surface of the outer tube of the nozzle. The means for preventing the liquid from flowing down does not need to be limited to the provision of the salient part 21″. A concave part, for example, may be provided in the place of the salient part 21″. The part directly preceding this concave part discharges a function similar to the salient part 21″ and can inhibit the liquid from flowing down.

By forming the upper case 23b′ of a raw material, such as soft resin, which deforms when exposed to an external force and, when relieved of the external force, restores by itself to the state existing prior to the deformation and by further providing the upper case 23b′ at a proper place on the upper surface thereof (the region approximating the delivery nozzle 21, for example) with a convex thin-wall part 50a and a depressing part 50b extended from the central lower surface of the thin-wall part 50a, it is made possible to give rise to a switching part 50 which is capable of deforming under an external force and restoring by itself to the original state. When this switching part 50 is exposed to an external pressure capable of forcing the switching part into the housing (specifically by depressing the switching part 50 with a finger), the depressing part 50b depresses the second contact piece 27 till the upper terminal part of the auxiliary contact piece 27′ contacts the second contact piece 27, the circuit is closed, and the motor 31 is turned on. Conversely, when the switching part 50 is relieved of the external pressure (specifically by lifting the lowered finger), the thin-wall part 50a restores to its original state and the depressing part 50b returns to its original position, with the result that the second contact piece 27 will separate from the upper terminal part of the auxiliary contact piece 27′ and the motor 31 will be turned off.

When the switching part 50 is formed as part of the upper case 23b′ in the housing 201 as contemplated in the present embodiment, it brings the advantage of lowering the cost as compared with the formation of a switching part with separately manufactured parts, such as a button and packing. When the thin-wall part 50a of the switching part 50 happens to have the adequate self-restoring function thereof impaired as by sustaining a fracture, the replacement exclusively of the upper case 23b′ with a new supply suffices to mend the ensuing hardship. The lower case 23a and similar components can be continuously used meanwhile. When the switching part 50 is disposed at a position such that it may be manipulated as held in a state of effectively receiving the liquid discharged from the exhaust port of the delivery nozzle 21, it can be utilized effectively in one hand.

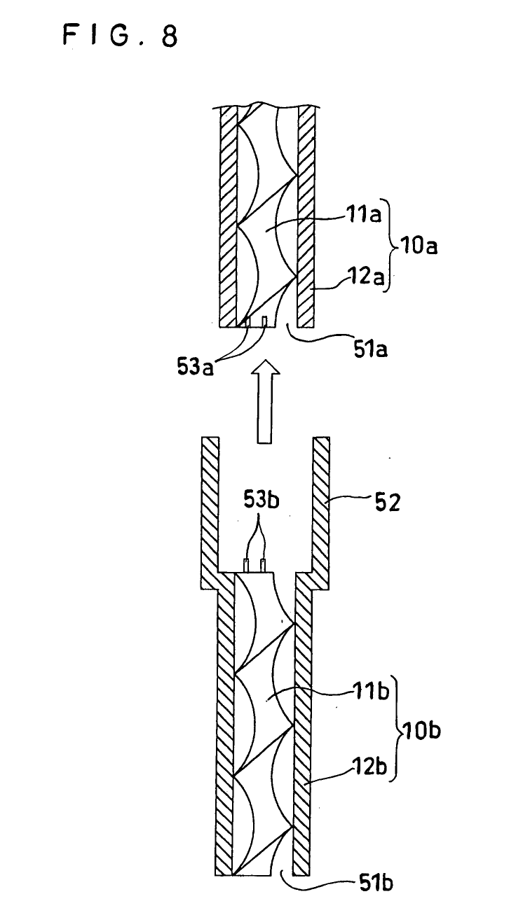

Now, an example of manufacturing a liquid-lifting means in a joint construction adapted to permit connection of the component parts thereof with a view to affording a liquid dispenser usable in the general-purpose pattern for liquid containers of varying depths will be described below with reference to FIG. 8. A connecting tube 52 formed on the upper end side of a connecting liquid-lifting means 10b comprising a helical screw 11b and a cylindrical tube 12b is attached to a liquid-lifting mouth 51 a side which constitutes the lower terminal part of a connected liquid-lifting means 10a comprising a helical screw 11a and a cylindrical tube 12a, for example. At this time, in order that the helical screw 11a and the helical screw 11b may be connected as held in a state of proper helix in consequence of the insertion of connecting salient parts 53b formed on the upper end surface of the helical screw 11b of the connecting liquid-lifting means 10b into connecting concave parts 53a formed on the lower end surface of the helical screw 11a of the connected liquid-lifting means 10a, the positions for setting up the connecting concave part 53a and the connecting salient part 53b are adjusted in advance.

The connection of the connected liquid-lifting means 10a and the connecting liquid-lifting means 10b which is effected as described above results in extending the liquid lifting mouth 51a which constituted the lower end of the opening of the connected liquid lifting means 10a to the liquid lifting mouth 51b which constitutes the lower end of the opening of the connecting liquid lifting means 10b and elongating the lifting path for the whole liquid-lifting means. In the example described above, the connecting concave parts 53a formed on the lower end surface of the helical screw 11a of the connected liquid-lifting means 10a and the connecting salient parts 53b formed on the upper end surface of the helical screw 11b of the connecting liquid-lifting means 10b have been depicted respectively as one example of the coupling means. They need not be particularly limited in structure. They may be in the form of screws, for example, on the condition that the connection aimed at is attained without impairing the liquid lifting function. Optionally, connecting concave parts may be formed on the lower end surface of the helical screw 11b of the connecting liquid lifting means 10b so as to permit connection thereto of other connecting liquid lifting means.

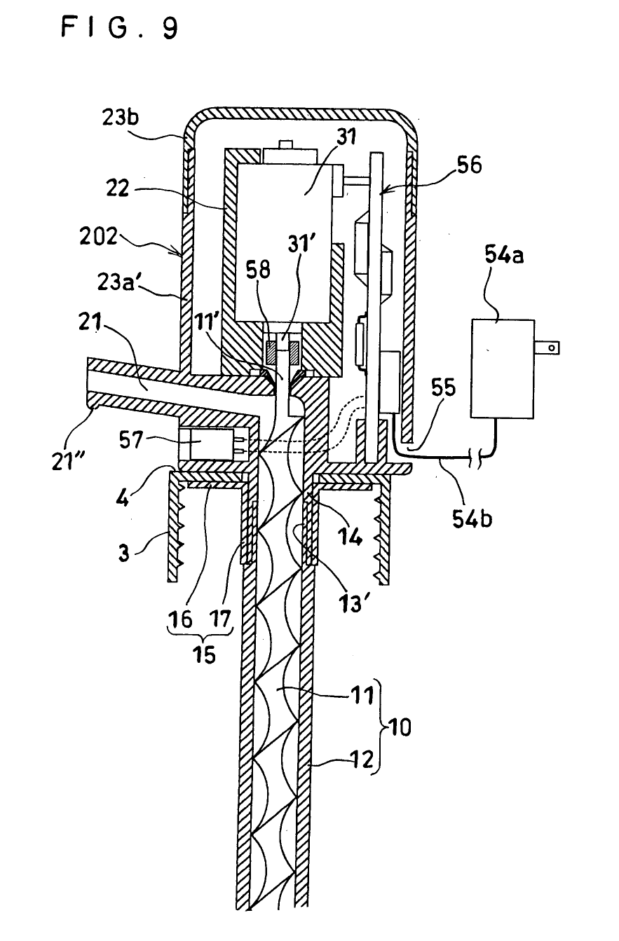

The preceding embodiments have been depicted as adopting a battery for supply of electric driving power and using a contact switch for the driving and stopping motions. These items, however, do not need to be exclusively designated for specification. Now, the liquid dispenser according to the third embodiment of this invention will be described in detail below with reference to FIG. 9. In this diagram, like functions found in the preceding diagrams illustrating the former embodiments will be denoted by like reference numerals. They will be omitted from the following description.

The liquid dispenser according to the present embodiment has a control base 56 set up in a lower case 23a′ which is furnished with a power source cord-inserting hole 55 for guiding into a housing 202 a cord 54b of an AC/DC switching adapter 54a serving the purpose of converting a commercial AC power source to a DC power source of a properly lowered pressure. This control base 56 is intended to actuate a non-contact sensor 57 by utilizing the electric power supplied from the AC/DC switching adapter 54a and turn on the motor 31 based on the detected output of the non-contact sensor 57 as well. Optionally, the power source cord-inserting hole 55 may be sealed with a proper sealing means with a view to exalting the airtightness of the interior of the housing 202.

The non-contact sensor 57 is disposed in the lower part located at the basal terminal of the delivery nozzle 21, for example, so as to be enabled to sense the arrival of a hand at the position for receiving the liquid emanating from the exhaust port of the delivery nozzle 21 and use the direction of extension of the delivery nozzle 21 as the scope of detection. Further in the present embodiment, the shaft 31′ of the motor 31 is directly connected to the shaft 11′ of the helical screw 11 with a rubber tube 58. When the liquid lifted with the liquid-lifting means 10 which is formed of the helical screw 11 and the cylindrical tube 12 happens to have low viscosity, since the helical screw 11 is required to be rotated at a high rate of speed, it possibly proves advantageous to adopt a structure for transmitting the rotation of the motor 31 directly to the helical screw without using the medium of a speed-reducing mechanism as contemplated by the present embodiment. The use of an external power source in the place of the built-in battery coupled with the obviation of the necessity for using the speed-reducing mechanism can be expected to result in decreasing the housing 202 in both size and weight because the empty part of the lower case 23a′ for accommodating the helical screw-driving means can be cut markedly.

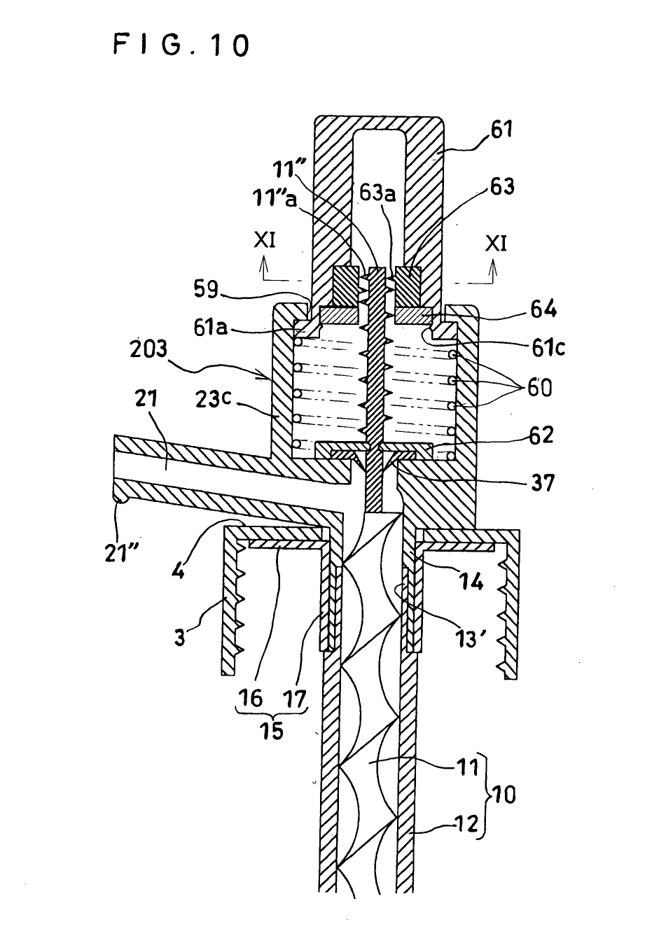

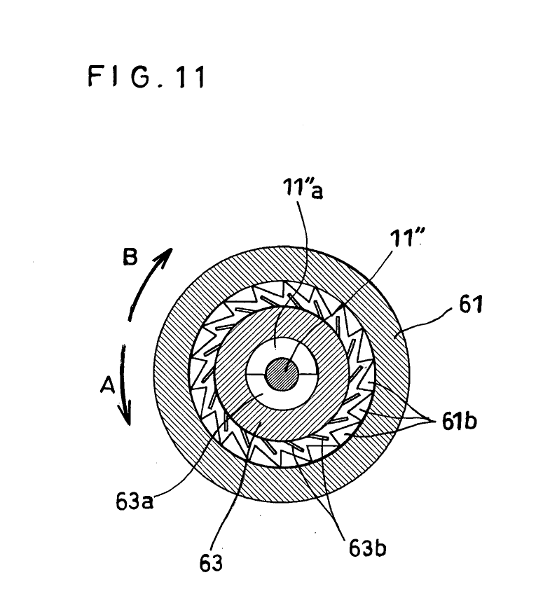

Each of the preceding embodiments has been depicted as being furnished with a helical screw-driving means using an electrical driving source. This item does not need to be exclusively designated for specification. A structure furnished with an operating handle simply serving the purpose of imparting necessary rotation to the rotary shaft of the helical screw may be used instead. It is nevertheless preferable to adopt a structure that is capable of inducing the discharge of the liquid by the depression with a finger or a palm similarly to the conventional air pump type liquid dispenser. Now, the liquid dispenser according to the fourth embodiment of this invention will be described in detail below with reference to FIG. 10 and FIG. 11. In these diagrams, like functions found in the preceding diagrams illustrating the former embodiments will be denoted by like reference numerals. They will be omitted from the following description.

A housing 203 of the liquid dispenser according to the present embodiment has a coil spring 60 inserted into the inner empty part of a main case 23c which is furnished on the upper surface thereof, for example, with a button-inserting hole 59 so that a dislocation-preventing part 61a extended in the lateral direction from the lower terminal edge of a button 61 protruding from the button-inserting hole 59 may be depressed against the inner upper part of the main case 23c by the coil spring 60. Specifically, the button 61 can be pushed into the main case 23c by depressing the button 61 against the resilient force of the coil spring 60 and can be pushed up to the original position by the coil spring 60 when the depression is discontinued.

By causing an annular groove formed at a proper point of the shaft 11″ of the helical screw 11 to be nipped with a screw-retaining plate 62 disposed inside the main case 23c, it is made possible to prevent the helical screw 11 from generating a vertical motion and enable it to rotate at a fixed position. The shaft 11″ of the helical screw 11 is provided with a helical threaded portion 11″a so adapted as to be meshed with a threaded portion 63a formed on the inner surface side of an annular rotation body 63.

The rotation body 63 is provided on the outer peripheral surface thereof with a multiplicity of thin-wall vanes 63a which jointly with as many ratchets 61b formed on the surface of the inside perimeter of the button 61 form a ratchet mechanism for allowing rotation only in one fixed direction. Incidentally, the rotation body 61 is retained by a rotation body-retaining plate 64 in a state generating free rotation only in one fixed direction at a fixed position inside the button 61. This rotation body-retaining plate 64 is set fast at a fixed position with a dislocation-preventing salient part 61c of the button 61.

In the liquid dispenser constructed as described above, when the button 61 is depressed against the resiliency of the coil spring 60, the rotation body 63 is caused to generate a turning force in the direction of A in the bearings of FIG. 11 owing to the state of occlusion between a threaded portion 63a of the rotation body 63 and the threaded portion 11″a of the shaft 11′ of the helical screw 11. The rotation in this direction, however, is not allowed to occur because of the locking with the ratchet mechanism. As a result, the shaft 11′ of the helical screw 11 is made to rotate in the direction of B and the liquid in the container is lifted in consequence of the rotation of the helical screw 11.

The button 61 is elevated by the resilient force of the coil spring 60 when the button 61 is pushed into the main case 23c as described above and then the depressing force is released by the removal of the hand. At this time, the rotation body 63 is caused to generate a turning force in the direction of B in the bearings of FIG. 11 by the state of occlusion between the threaded portion 63a of the rotation body 63 and the threaded portion 11″a of the shaft 11″ of the helical screw 11. Since the locking with the ratchet mechanism is not effectuated in this direction, the rotation body 63 per se continues to rotate and elevates itself in unison with the button 61 and is not allowed to rotate the shaft 11″ of the helical screw 11. That is, the possibility of the elevation of the button 61 resulting in reversely rotating the helical screw 11 and forcibly returning the liquid in the cylindrical tube 12 downward can be precluded.

The liquid dispenser according to the fourth embodiment described above can be offered at a low cost because it completes the helical screw-driving means without using an electrical drive source composed of expensive parts, such as a motor and a power source.

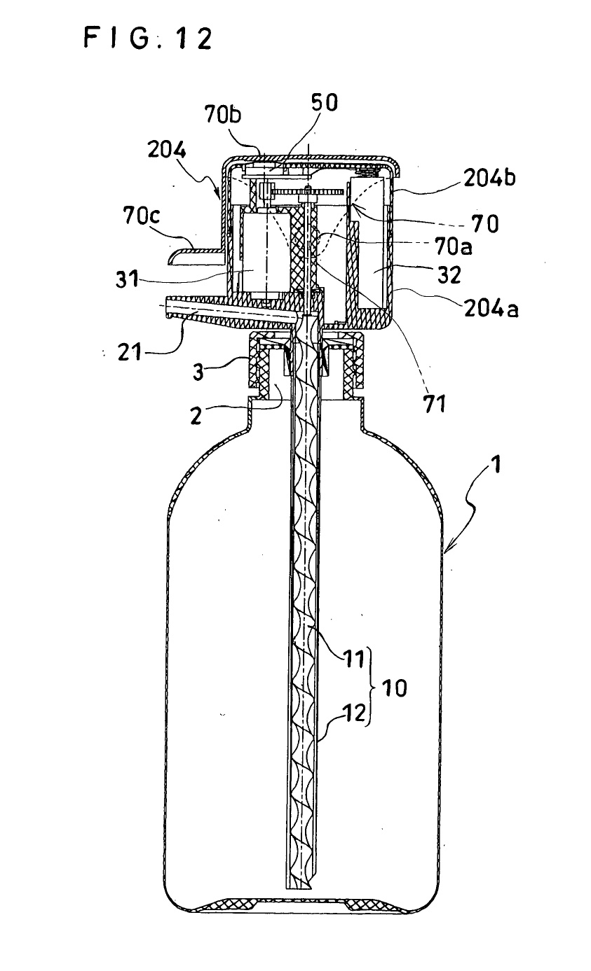

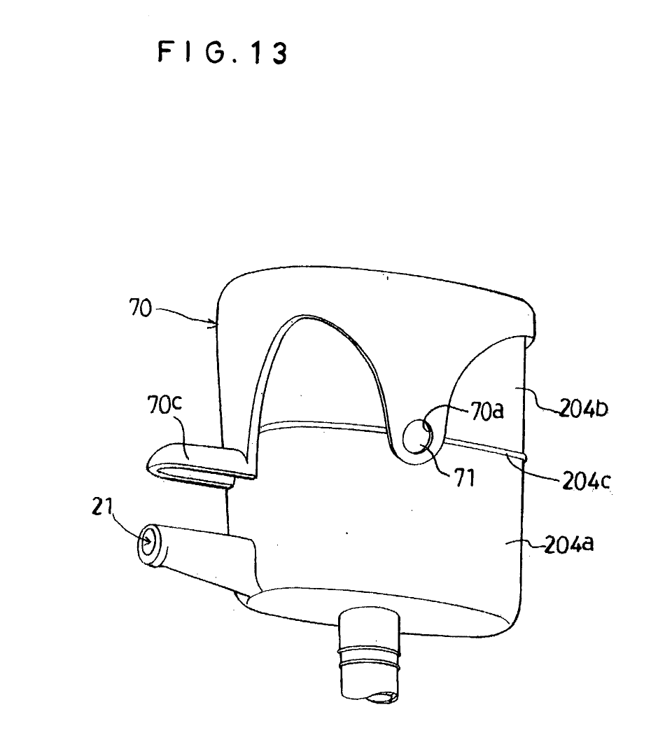

Though the second embodiment cited above has been described as causing the electrical driving source to be actuated by directly depressing the switching part formed on the upper surface of the housing, the on-off operations of the electrical driving source do not need to be particularly limited to this direct depression of the switching part. In the liquid dispenser according to the second embodiment, since the switch is separate far from the exhaust port for the liquid, the operator finds the work of receiving the liquid by depressing the switch in one hand difficult to achieve. The liquid dispenser according to the fifth embodiment of the invention that has solved this difficulty will be described in detail below with reference to FIG. 12 and FIG. 13. In these diagrams, like functions found in the preceding diagrams illustrating the former embodiments will be denoted by like reference numerals. They will be omitted from the following description.

A housing 204 of the liquid dispenser illustrated in the fifth embodiment is composed of a lower case 204a and an upper case 204b. An auxiliary switching piece 70 of an arbitrary shape destined to cover part of the housing 204 is disposed in a manner capable of generating oscillation.

This auxiliary switching piece 70 is so shaped as to cover the upper case 204b having the switching part 50 formed on the top surface thereof and extend bearings downward from the lateral opposite sides thereof and an auxiliary operating body-shaping part downward from the front side thereof (FIG. 13). Then, in the bearings of the auxiliary switching piece 70, bearing holes 70a are opened bilaterally. A slight air gap occurs between the outer surface of the housing 204 and the inner surface of the auxiliary switching piece 70 after the bearing holes 70a have fallen home into bearing-protruding parts 71 that are formed bilaterally on the housing 204. Thus, the auxiliary switching piece 70 is enabled to oscillate in the longitudinal direction (the direction of extension of the delivery nozzle 21).

When the auxiliary switching piece 70 constructed as described above is tilted forward, the motor 31 is turned on and the liquid is lifted because a switch-depressing part 70b is made to depress the switching part 50. To be specific, when the switch-depressing part 70b of the auxiliary switching piece 70 is depressed with a finger, the auxiliary switching piece 70 itself is tilted forward and the switching part 50 formed on the top surface of the upper case 204b is pushed in till the electrical driving source is set operating. When the finger is removed from the switch-depressing part 70b, the switching part 50 formed on the top surface of the upper case 204b is automatically reset to stop the electrical driving source.

The auxiliary operating body-shaping part of the auxiliary switching piece 70 is provided in the lower edge part thereof with an auxiliary operating body 70c. This auxiliary operating body 70c is projected above the delivery nozzle 21 in nearly the same direction (FIG. 13). An attempt to push this auxiliary operating body 70c downward results in causing the auxiliary switching piece 70 itself to tilt forward, inducing the switch-depressing part 70b to depress the switching part 50, turning the motor 31 on and enabling the liquid to be lifted. By pushing and releasing this auxiliary operating body 70c, therefore, it is made possible to carry out the on-off operations of the electrical driving source. Incidentally, the auxiliary operating body 70c illustrated in the diagram is formed in a semi-cylindrical shape, namely a structure that increases the strength of the material thereof and prevents the body from being broken or bent accidentally.

The liquid dispenser according to the fifth embodiment is furnished with the auxiliary switching piece 70 and consequently enabled by the oscillating motion thereof to depress/release the switching part 50 as described above. Thus, it is allowed to carry out the on-off operations of the electrical driving source without requiring a direct operation of the switching part 50. An effort to enlarge the range of operation of the switch and approximate the exhaust port of the delivery nozzle 21 to the auxiliary operating body 70c as described above can be expected to enhance the convenience of the liquid dispenser further even to the extent of enabling a child of a small hand to easily operate this liquid dispenser in one hand.

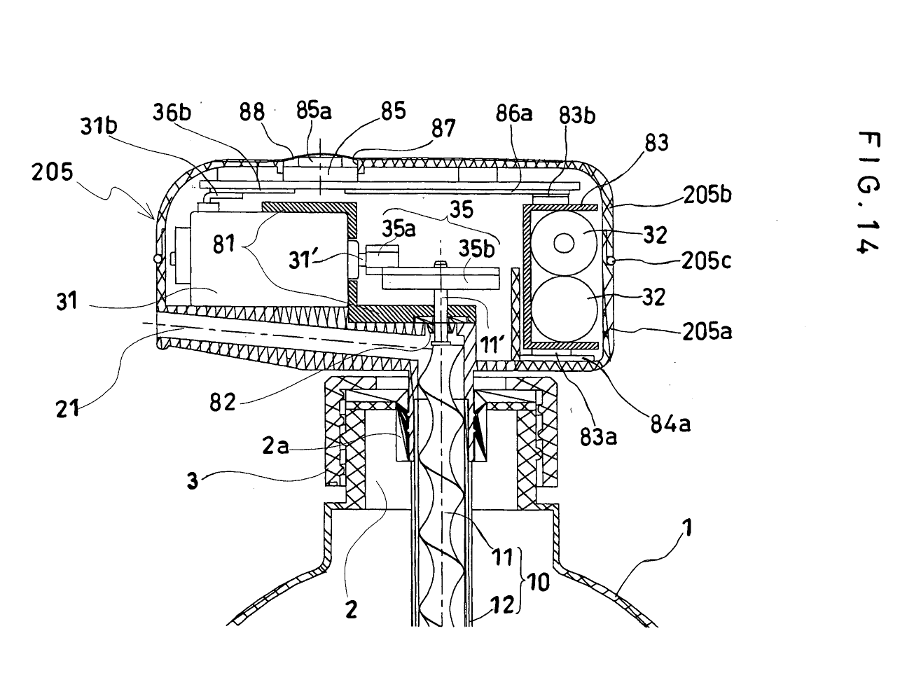

In the fifth embodiment described above, by providing the auxiliary switching piece, it is made possible to realize the operation of the liquid dispenser by one hand even when the exhaust port of the delivery nozzle is separate far from the switching part. Alternatively, by decreasing the height of the housing and consequently approximating the switching part to the exhaust port of the delivery nozzle, it is made possible to facilitate the operation by one hand. Now, the liquid dispenser according to the sixth embodiment that is directed toward forming the housing in a decreased thickness will be described below with reference to FIG. 14 to FIG. 16.

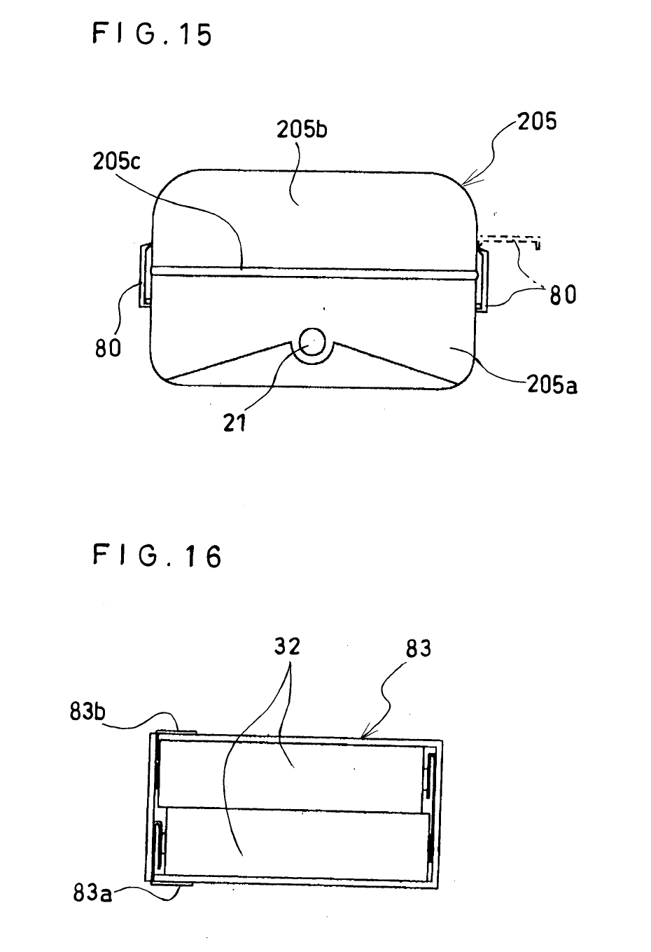

A housing 205 of the liquid dispenser according to the sixth embodiment is composed of a thin lower case 205a and a thin upper case 205b and is furnished in the intervening space between the upper case 205b and the lower case 205a with annular packing 205c which is intended to protect the interiors of these cases against invasion of water. The upper case 205b is provided on the bilateral sides thereof with mounting pieces 80 each resembling a hinge in structure (FIG. 15). By inserting the mounting pieces 80 into the inserting concave parts formed at proper positions on the bilateral faces of the lower case 205a, it is made possible to render the upper case 205b removable relative to the lower case 205a.

The helical screw-driving means which is accommodated in the housing 205 constructed as described above is composed of the motor 31 which has the rotating shaft 31′ thereof laid sideways for the sake of restraining height, a driving force-transmitting mechanism (the reducing gear-transmitting device 35 formed of the gear 35a and the gear 35c) which transmits the rotation of the rotating shaft 31′ of the motor 31 as the driving force to the helical screw 11, and the lateral batteries 32 which feed the motor 31 with an electric driving force.

A motor-retaining place 81 for fixing the motor 31 to the lower case 205a is endowed with a function of fixing the motor 31 and a function of retaining packing 82 for preventing the lifted liquid from invading the interior of the housing 205 and is fixed to the lower case 205a as with screws. By providing the mouth 2 of the container with an inside plug 2a, it is made possible to exalt the tightness of sealing of the mouth which is obtained by the attachment of the cap 3.

The batteries 32 are accommodated sideways in a battery case 83 and are mounted together with the battery case 83 on the lower case 205a. By imparting a removable form to the battery case 83 to be used, it is made possible to facilitate the replacement of such batteries. Optionally, the batteries 32 may be placed in a piled state, i.e. one placed on top of the other, in the lower case 205a and the necessity for using the battery case 83 may be obviated. The storage of the batteries in this manner, however, results in impairing the efficiency of the operation.

A positive pole-conducting piece 83a connected to the +poles of the batteries 32 is located at the lower end of the battery case 83 (FIG. 16) and a conducting piece 84a connected to the +pole of the motor is located in the corresponding region of the lower case 205b. The continuity is established between the +pole of the batteries 32 and the +pole of the motor 31 when the battery case 83 is attached to the lower case 205a.

A negative pole-conducting piece 32b connected to the −poles of the batteries 32 is located at the upper end of the battery case 83 and a printed board electric pole 86a connected to one of the terminals of a switch 85 is located at the corresponding region of the upper case 205b. The continuity between one of the electric poles of the switch 85 and the −pole of the battery 32 is established when the upper case 205b is made to cover the lower case 205a. Further, a printed board electric pole 86b connected to the other electric pole of the switch 85 is located in the region of the upper case 205b corresponding to the region of the conducting piece 31b attached to the −pole of the motor 31. The continuity of the other electric pole of the switch 85 to the −pole of the motor 31 is established when the upper case 205b is made to cover the lower case 205a.

The switch 85 is intended to perform the continuity/non-continuity switching between the printed board electric poles 86a and 86b. By utilizing a switch-inserting hole 87 opened at a proper position on the upper surface of the upper case 205a for allowing a switching part 85a to protrude slightly in advance and attaching a switch-protecting seal 88 using a thin sheet material made of resin to the upper surface of the upper case 205a, it is made possible to complete a structure which enables the switch 85 to be turned on and off from outside the housing 205.

By enabling the housing 205 to efficiently accommodate the helical screw-driving means therein and consequently attain a decrease in the thickness of structure as in the present embodiment, it is made possible to make the switch 50 approach the exhaust port of the delivery nozzle 21 and permit even a child of a small hand to manipulate the switch easily in one hand.

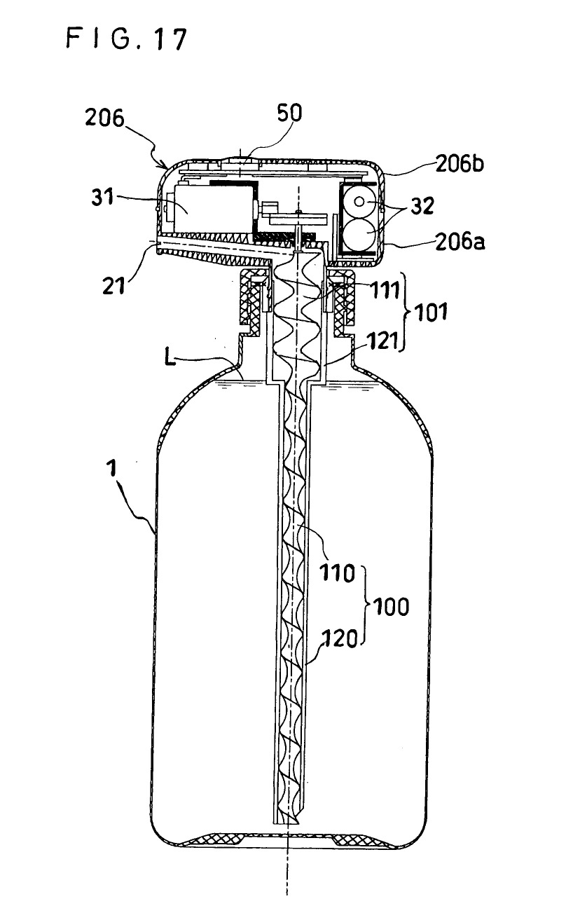

A liquid detergent, such as hand soap or body soap, is generally put to use after it has been dispensed on a hand and rubbed thereon till it foams. When the liquid for the purpose of this use can be supplied in a foamed state, therefore, it will enjoy an enhanced convenience. Now, a liquid dispenser according to the seventh embodiment that is endowed with a function of foaming the liquid will be explained below with reference to FIG. 17.

A housing 206 of the liquid dispenser according to the seventh embodiment has a thin structure similarly to the housing of the sixth embodiment cited above. It is produced by forming an air bubble-mixing part 101 composed of an upper helical screw 111 of an enlarged diameter and an upper cylindrical tube 121 on a liquid-lifting means 100 composed of a lower helical screw 110 and a lower cylindrical tube 120 similar in size to the relevant components of each of the embodiments cited above.

When the liquid dispenser so constructed has the upper helical screw 111 of the enlarged diameter and the upper cylindrical tube 121 positioned above the level L of the liquid placed in the container 1 to the largest possible capacity thereof, the amount of the liquid lifted in the air bubble-mixing part 101 is increased. The liquid-lifting means 100 which is composed of the lower helical screw 110 and the lower cylindrical tube 120, however, is incapable of lifting the liquid so much as to fill the air bubble-mixing part 101. Thus, the air existing in the air bubble-mixing part 101 from the beginning and the lifted liquid are mixed by the rotational force of the upper helical screw 111 and the foamed liquid consequently produced is supplied to the delivery nozzle 21 and discharged to the exterior of the liquid dispenser. The liquid dispenser according to the present embodiment, therefore, is capable of supplying the liquid detergent, such as hand soap or body soap, in a foamed state and enhancing the convenience on the part of the user.

For the purpose of foaming the liquid more efficiently, a varying method such as, for example, forming protuberances inside the upper cylindrical tube 121 in the air bubble-mixing part 101, wrapping a brush-like object around the groove in the upper helical screw 111, or setting a mesh in the groove of the upper helical screw 111, can be adopted.

The liquid dispensers according to various embodiments of this invention have been illustrated. They can be applied to containers intended to hold various liquids. When the liquid dispenser using an electrical driving source is applied to a container for holding a liquid of comparatively high viscosity, such as shampoo, even a child or old man of weak force can lift the liquid easily from the container in one hand. When this liquid dispenser is applied to a container for holding a liquid-flavoring material, such as vinegar or soybean paste, it is enabled to facilitate the dispensation of the liquid into measuring spoons during the course of cooking. When it is applied to a container for holding a drinking chemical solution, it is enabled to facilitate the dispensation of the solution into measuring caps at the time of drinking. When it is applied to a soap solution-feeding mechanism, i.e. a toy for emitting soap bubbles, it is enabled to supply continuously the soap solution automatically.

The liquid dispenser of this invention for use with the liquid container is contemplated to make use of the lifting means that is composed of a helical screw and a cylindrical tube as described above. Therefore, by rotating the helical screw through the a helical screw-driving means, it is made possible to lift the liquid in the container and discharge it through the delivery nozzle. It is, therefore, capable of lifting not only a liquid of high viscosity, such as shampoo or rinse, but also a fluid of extremely high viscosity, such as grease. Moreover, even when a container of a comparatively large size happens to hold a liquid for delivery in a large amount, the possibility of the operation by a child or an old man becoming difficult as experienced by the conventional liquid dispenser of the air pump type can be effectively prevented because the load required in rotating the helical screw cannot increase extremely.

The liquid dispenser for the liquid container is provided with a helical screw-driving means that drives the helical screw with an electrical driving source capable of being driven and stopped with a switch disposed at a proper position in the housing. It is, therefore, enabled to lift the liquid more easily than when a manual helical screw-driving means is operated.

Further, the liquid dispenser for the liquid container is furnished as part of the upper case in the housing with a switching part whose electrical driving source is actuated when it is given a push as with a finger and stopped when the finger is removed. It is, therefore, at an advantage in repressing the cost more than when the switching part is formed by separately incorporating a button or packing therein. When this liquid dispenser happens to have the adequate self-restoring function thereof impaired such as by suffering the thin-wall part, i.e. the switching part, to sustain a fracture, the replacement of the upper case alone suffices to mend the ensuing hardship.

Since the liquid dispenser for the liquid container is furnished in the lower part of the exhaust port of the delivery nozzle with a liquid efflux-preventing means, the flow of the discharged liquid from the exhaust port along the lower surface of the outer tube of the nozzle toward the main body of the housing can be effectively precluded by having the delivery nozzle disposed in an upward direction.

The liquid dispenser for the liquid container is enabled to extend the helical screw and the cylindrical tube using those for extension by utilizing attaching-detaching means that are provided for the helical screws in the liquid-lifting means. It is consequently enabled to have the lifting path in the liquid-lifting means properly extended proportionately to the depth of the liquid container and acquire flexibility high enough to suit various liquid containers.

Further, the liquid dispenser for the liquid container is furnished with an auxiliary switching piece which is so shaped as to cover at least the switching part of the housing and so adapted as to switch between the state generating no action on the switching part and the state exerting a depression on the switching part and is consequently enabled to utilize the swinging motion of this auxiliary switching piece for operating the switch of the electrical driving source of the helical screw-driving means. It is, therefore, enabled to obviate the necessity for directly depressing the switching part, enlarge the range of the operation of the switch and heighten the convenience on the part of the user.

In the liquid dispenser for the liquid container, the helical screw-driving means to be accommodated in the housing is composed of a motor having the rotational shaft thereof disposed sideways, a driving force-transmitting mechanism for transmitting the rotation of the rotational shaft of the motor as the driving force to the helical screw, and batteries disposed sideways and adapted to feed a driving electric force to the motor. This liquid dispenser, therefore, is enabled to form the housing in a decreased thickness, shorten the distance between the switching part of the upper case and the delivery nozzle and warrant easy operation in one hand even for a child.

Further, in the liquid dispenser for the liquid container, the liquid-lifting means is furnished in the upper part thereof with an air bubble-mixing part formed by enlarging the helical screw and the cylindrical tube diametrically and consequently enabled to foam the lifted liquid in the air bubble-mixing part and emit the foamed liquid through the delivery nozzle. This liquid dispenser, therefore, is capable of supplying a liquid detergent, such as hand soap or body soap, in a foamed state and enhancing the convenience on the part of the user.

What is claimed is:

1. A liquid dispenser for a cap which is fitted to a mouth of a container holding a liquid therein, which liquid dispenser comprises a liquid-lifting means supported on an upper wall of the cap as pierced therethrough and comprised of a helical screw and a cylindrical tube encompassing the helical screw, both having upper terminal parts thrust upward individually from the upper wall and lower terminal parts inserted into the container when the cap is fitted to the mouth of the container; and a housing adapted to accommodate therein a helical screw-driving means for rotating the helical screw in the liquid-lifting means and furnished with a delivery nozzle for allowing a liquid lifted by the liquid-lifting means to flow out of the liquid dispenser.

2. The liquid dispenser according to claim 1, wherein the helical screw-driving means is adapted to transmit a driving force of an electrical driving source and rotate the helical screw, and the housing is provided at a proper position thereof with a switch for driving and stopping the electrical driving source.

3. The liquid dispenser according to claim 2, wherein the housing is comprised of a lower case having an empty storage part for accommodating the helical screw-driving means and a top face opening, and an upper case of a shape of a cover for blocking the top face opening of the lower case; the upper case is made of a material capable of deformation under an external force and restoration to an original shape by itself from the deformation and is furnished with a thin-wall part so as to function as a switching part capable of deformation under an external force and restoration to an original shape by itself from the deformation, and the switching part is consequently adapted to turn on the electrical driving source by application of an external pressure for depressing the switching part into the housing and turn off the electrical driving source by releasing the external force applied to the switching part, thereby allowing the switching part to resume an original state.

4. The liquid dispenser according to claim 1, wherein the delivery nozzle of the housing is disposed in an upward direction for enabling a liquid lifted by the liquid-lifting means to advance through an upwardly inclined path and reach an exhaust port and the delivery nozzle is provided in a lower part of the exhaust port with a liquid flow-inhibiting means for inhibiting a discharged liquid from flowing out of the exhaust port, down a lower face of an outer tube of the nozzle, toward a main body side of the housing.

5. The liquid dispenser according to claim 1, wherein the liquid-lifting means is provided at a terminal part of the helical screw with first attaching-detaching means, and the liquid dispenser further comprises second liquid-lifting means comprising a second helical screw and a second cylindrical tube encompassing the second helical screw and provided at a terminal part of the second helical screw with second attaching-detaching means so that the two liquid-lifting means are rendered attachable and detachable through the first and second attaching-detaching means, whereby the liquid-lifting means is adapted for extension and has a lifting path therein rendered extendable proportionately to a depth of the container.

6. The liquid dispenser according to claim 3, wherein the switching part is provided with an auxiliary switching piece shaped to cover at least the switching part of the housing and rendered shiftable between a state incapable of acting on the switching part and a state capable of depressing the switching part, and the electrical driving source of the helical screw-driving means is switched by a shifting motion of the auxiliary switching piece.

7. The liquid dispenser according to claim 4, wherein the switching part is provided with an auxiliary switching piece shaped to cover at least the switching part of the housing and rendered shiftable between a state incapable of acting on the switching part and a state capable of depressing the switching part, and the electrical driving source of the helical screw-driving means is switched by a shifting motion of the auxiliary switching piece.

8. The liquid dispenser according to claim 5, wherein the switching part is provided with an auxiliary switching piece shaped to cover at least the switching part of the housing and rendered shiftable between a state incapable of acting on the switching part and a state capable of depressing the switching part, and the electrical driving source of the helical screw-driving means is switched by a shifting motion of the auxiliary switching piece.

9. The liquid dispenser according to claim 3, wherein the helical screw-driving means comprises a motor having a rotational shaft disposed in a lateral direction therein, which motor is the electrical driving source, a driving force-transmitting mechanism for transmitting rotation of the rotational shaft as the driving force for the helical screw, and a laterally disposed battery for feeding electricity to the motor to complete the housing in a thin construction.

10. The liquid dispenser according to claim 4, wherein the helical screw-driving means comprises a motor having a rotational shaft disposed in a lateral direction therein, which motor is the electrical driving source, a driving force-transmitting mechanism for transmitting rotation of the rotational shaft as the driving force for the helical screw, and a laterally disposed battery for feeding electricity to the motor to complete the housing in a thin construction.

11. The liquid dispenser according to claim 5, wherein the helical screw-driving means comprises a motor having a rotational shaft disposed in a lateral direction therein, which motor is the electrical driving source, a driving force-transmitting mechanism for transmitting rotation of the rotational shaft as the driving force for the helical screw, and a laterally disposed battery for feeding electricity to the motor to complete the housing in a thin construction.

12. The liquid dispenser according to claim 6, wherein the helical screw-driving means comprises a motor having a rotational shaft disposed in a lateral direction therein, which motor is the electrical driving source, a driving force-transmitting mechanism for transmitting rotation of the rotational shaft as the driving force for the helical screw, and a laterally disposed battery for feeding electricity to the motor to complete the housing in a thin construction.

13. The liquid dispenser according to claim 1, wherein the liquid-lifting means has in an upper part thereof an air-bubble mixing part comprising a diametrically enlarged helical screw and a diametrically enlarged cylindrical tube, and the lifted liquid is foamed in the air-bubble mixing part and allowed to flow out of the liquid dispenser through the delivery nozzle.
